(19) United States
(12) Patent Application Publication
(10) Pub. No.: US 2010/0323611 A1
(43) Pub. Date: Dec. 23, 2010

(54) SYSTEMS AND METHODS FOR COHERENT PRECODING WITH ANTENNA SELECTION FOR COORDINATED MULTIPOINT TRANSMISSION

(75) Inventor: Sayantan Choudhury, Vancouver, WA (US)

Correspondence Address: AUSTIN RAPP & HARDMAN, 170 SOUTH MAIN STREET, SUITE 735, SALT LAKE CITY, UT, 84101, US

(73) Assignee: Sharp Laboratories of America, Inc., Camas, WA (US)

(21) Appl. No.: 12/488,445

(22) Filed: Jun. 19, 2009

(51) Int. Cl. H04B 7/00; H04B 7/14

(52) U.S. Cl. 455/7; 455/507

(57) ABSTRACT

Downlink data may be transmitted from cooperating base stations to a user equipment (UE). Different numbers of transmit antennas may be selected for use at different cooperating base stations. Coherent weighting may be performed at each of the transmission points. The UE may estimate channels from individual cooperating base stations and combine the individual channels to form an improved combined channel by selecting the transmit antennas and weights to be used at each transmission point.

### TECHNICAL FIELD

The present disclosure relates generally to wireless communications. More specifically, the present disclosure relates to coordinated multipoint transmission in a cellular network.

### BACKGROUND

A cellular network is a radio network made up of a number of radio cells (or just cells) each served by a fixed transmitter, known as a cell site or base station. These cells are used to cover different areas in order to provide radio coverage over a wider area than the area of one cell. Cellular networks include a set of fixed main transceivers each serving a cell and a set of distributed transceivers (which are generally, but not always, mobile) that provide services to the network's users.

There are a number of standards organizations that attempt to develop standards for cellular networks. One example of such a standards organization is the 3rd Generation Partnership Project (3GPP). 3GPP LTE (Long Term Evolution) is the name given to a project within 3GPP to improve the Universal Mobile Telecommunications System (UMTS) standard to cope with future technology evolutions. 3GPP LTE Advanced is currently being standardized by 3GPP as an enhancement of 3GPP LTE.

Coordinated multiple point transmission/reception (CoMP) is considered one of the promising technologies to improve the performance of 3GPP LTE Advanced. The main idea of CoMP is to transmit the information from multiple base stations to a user equipment (UE) resulting in better signal quality at the UE due to the combining capability of the multiple transmissions at the UE.

One form of combining proposed was MBSFN (Multicast Broadcast Single Frequency Network) like transmission where multiple base stations transmit the same signal to the UE. The main idea of the MBSFN is to transmit the same data from multiple base stations. At the receiving UE, the received signal appears to be from the sum of the individual channels from the individual base stations to the UE. The present disclosure relates to improvements to this MBSFN transmission scheme in the context of coordinated multiple point transmission/reception. The methods disclosed herein may also be utilized in connection with other types of transmission schemes (e.g., global preceding).

### BRIEF DESCRIPTION OF THE DRAWINGS

FIG. 1 illustrates an MBSFN preceding scheme involving two CoMP cells;

FIG. 2 illustrates a system that is configured for antenna selection with coherent combining preceding;

FIG. 3 illustrates another system that is configured for antenna selection with coherent combining preceding;

FIG. 4 illustrates a method for antenna selection with coherent combining preceding;

FIG. 5 illustrates another system that is configured for antenna selection with coherent combining preceding;

FIG. 6 illustrates another method for antenna selection with coherent combining preceding;

FIG. 7 illustrates another system that is configured for antenna selection with coherent combining preceding;

FIG. 8 illustrates another method for antenna selection with coherent combining preceding; and

FIG. 9 illustrates various components that may be utilized in a communication device.

### DETAILED DESCRIPTION

A method for coordinated multipoint transmission/reception is disclosed. Downlink data is transmitted from cooperating base stations to a user equipment (UE). Different numbers of transmit antennas are selected for use at different cooperating base stations. Coherent weighting is performed at each of the transmission points.

Uplink data may be transmitted from the UE to the cooperating base stations. Different numbers of receive antennas may be selected for use at different cooperating base stations. Coherent weighting may be performed at each of the reception points. The UE may estimate channels from individual cooperating base stations and combine the individual channels to form an improved combined channel by selecting the transmit antennas and weights to be used at each transmission point. Individual channels at the UE may be combined to form a better combined channel using antenna selection and coherent combining using local weighting.

The transmit antennas and weights of the cooperating base stations may be selected at the UE by estimating a superimposed channel of the cooperating base stations. The UE may estimate channels from individual cooperating base stations and coherently combine them to form an improved combined channel. A cooperating base station may estimate channels from the UE to form a better combined channel. Individual channels from the UE to a base station via relay nodes may be combined to form a better combined channel by selecting transmit antennas and weights to be used at each of the relay nodes.

The antenna selection indices from the UE along with the weights to be used for coherent combining may be fed back to the cooperating base stations in order to allow the individual cooperating base stations to select the antennas and weights to be used for transmission. The downlink data to be transmitted may be downlink shared data in a 3GPP LTE-like system. The uplink data to be transmitted may be uplink shared data in a 3GPP LTE-like system that employs relays.

The UE may use different metrics to estimate a configuration mode to be used at the cooperating base stations in order to improve a combined channel seen at the UE. Antenna selection may also be performed with respect to the UE.

A receiving node is disclosed. The receiving node includes a processor, memory in electronic communication with the processor, and instructions stored in the memory. The instructions are executable to estimate channels from multiple cooperating transmitting nodes to the receiving node. The instructions are also executable to determine a best combined channel by using different combinations of transmit antennas and weights for the multiple cooperating transmitting nodes. The instructions are also executable to notify the multiple cooperating transmitting nodes about the transmit antennas and the weights to be used for transmission of data to the receiving node.

The receiving node may be a user equipment (UE) and the transmitting nodes may be base stations. Alternatively, the receiving node may be a base station, and the transmitting nodes may be relay nodes or UEs. Determining the best combined channel may include optimizing a performance criterion.

A transmitting node is disclosed. The transmitting node includes a processor, memory in electronic communication with the processor, and instructions stored in the memory. The instructions are executable to receive feedback from a receiving node. The feedback includes an indication of one or more transmitting antennas and weights. The instructions are also executable to select the one or more transmitting antennas and the weights to be used for transmission of data to the receiving node based on the feedback from the receiving node. The instructions are also executable to transmit the data to the receiving node simultaneously with at least one other cooperating transmitting node using the selected transmitting antennas and the selected weights.

The receiving node may be a user equipment (UE), and the transmitting node and the at least on other cooperating transmitting node may be base stations. Alternatively, the receiving node may be a base station, and the transmitting node and the at least one other cooperating transmitting node may be relay nodes or UEs.

The techniques disclosed herein may be utilized to improve the performance of coordinated multipoint transmission by combining antenna selection with MBSFN transmission along with coherent combining from multiple cooperating base stations. To improve upon the performance of antenna selection with MBSFN, additional weights are used to align the signals from each of the individual cooperating base stations. While antenna selection by itself can eliminate some of the destructive superposition of signals in an MBSFN scheme, antenna selection with coherent combining can even constructively superpose the signals and lead to higher gain. This can be very useful in practice, since the preceding codebooks in general are quantized and hence antenna selection with coherent combining allows a method of constructively combining the signals by searching over an effective larger codebook space.

The techniques disclosed herein may be implemented in a 3GPP LTE-like system. The term “3GPP LTE-like system” includes any wireless communication system that operates in accordance with a 3GPP LTE standard, a 3GPP LTE-Advanced standard, etc.

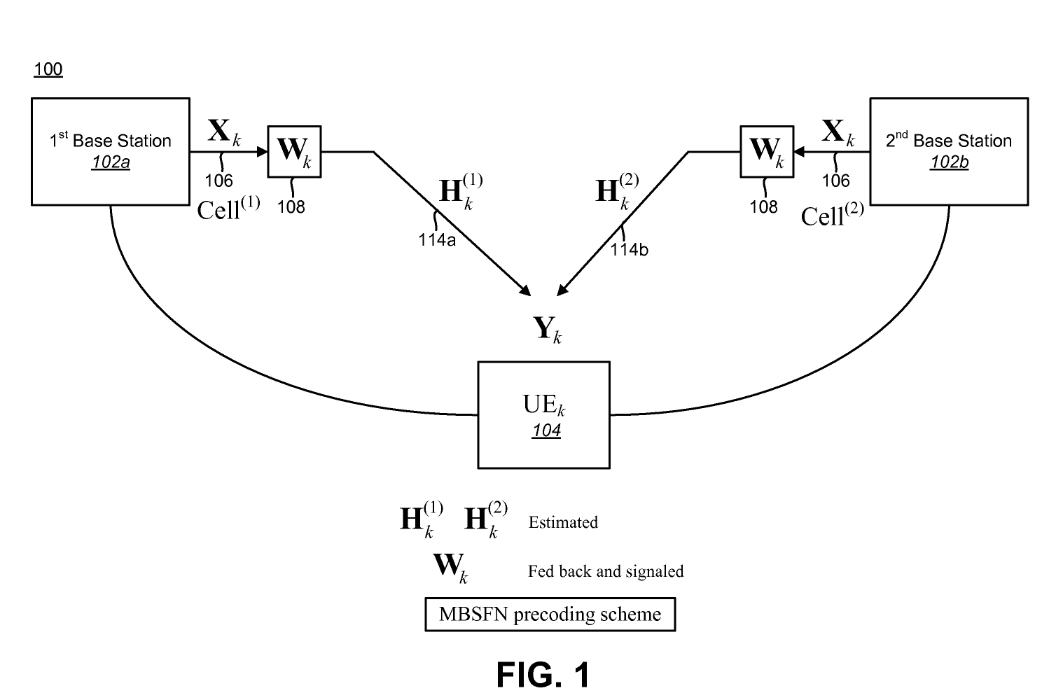

FIG. 1 illustrates an MBSFN preceding scheme 100 involving two CoMP (coordinated multiple point transmission/reception) cells. Multiple base stations 102a, 102b are shown transmitting data simultaneously to a UE 104. This is referred to as downlink joint processing CoMP in LTE-Advanced. The first base station 102a and the second base station 102b may be referred to as cooperating (or coordinating) base stations 102. In this context, cooperating (or coordinating) base stations 102 are base stations 102 that transmit the same data (or possibly different data) simultaneously to a UE 104.

At the first base station 102a, a preceding vector 108 is applied to the data 106. The resulting signal is transmitted over a first channel 114a to the UE 104. Similarly, at the second base station 102b, the preceding vector 108 is applied to the data 106. The resulting signal is transmitted over a second channel 114b to the UE 104.

Suppose the total number of CoMP cells (e.g., base stations 102) is B, each equipped with Nₜ transmit antennas. Let us assume that the receiver (e.g., the UE 104) has Nᵣ receive antennas. Let the baseband channel matrix between CoMP cell b (b=1,2 . . . B) and UEᵢ be denoted by Hᵢ(b) (Nᵣ×Nₜ). Let Wₖ(b) be the pre-coding matrix of cell b with size Nₜ×Lₖ, where Lₖ is the number of transmission layers for UEₖ.

In MBSFN pre-coding:

$${y}_{k} = ( {\sum }_{b = 1}^{B} \sqrt{{P}_{b}} {H}_{k}^{( b )} {W}_{k} ) {x}_{k} + {n}_{k} \qquad ( 1 )$$

where Wₖ is a common pre-coding matrix for all CoMP cells, whose columns are the Lₖ right singular vectors corresponding to the Lₖ largest singular values of the composite channel

$${\sum }_{b = 1}^{B} {H}_{k}^{( b )} ,$$

and \sqrt{P_{b}} is the power on each layer from CoMP cell b.

One of the problems with MBSFN pre-coding is that (with two cooperating base stations 102a, 102b) even if the individual channels from the base stations 102a, 102b to the receiver (H1 and H2) are good, the combined channel (H1+H2) might not be good. Therefore, we propose the use of antenna selection at each of the cooperating points in order to select the best combined channel H1′+H2′, where H1′ and H2′ are chosen by selecting subsets of antennas at the individual cooperating base stations 102a, 102b.

In the present disclosure, we propose a preceding technique using weighted preceding along with antenna selection. We further improve upon the performance by using local weights at each of the transmission points (e.g., a weight for each antenna) along with antenna selection. The effective received signal with antenna selection and coherent combining is given by:

$${y}_{k} = {\sum }_{b = 1}^{B} \sqrt{{P}_{b}} {H}_{k}^{′ ( b )} {W}_{k} ( {D}_{k}^{( b )} {x}_{k} ) + {n}_{k} \qquad ( 2 )$$

where Dₖ^{(b)} is a cell (or transmission point, antenna port, etc.) specific diagonal matrix consisting of Lₖ elements selected from a pre-defined codebook in order to coherently combine the signals from the multiple transmission points and H′ₖ^{(b)} is the effective channel (by selecting one or many antennas) from each cooperating point.

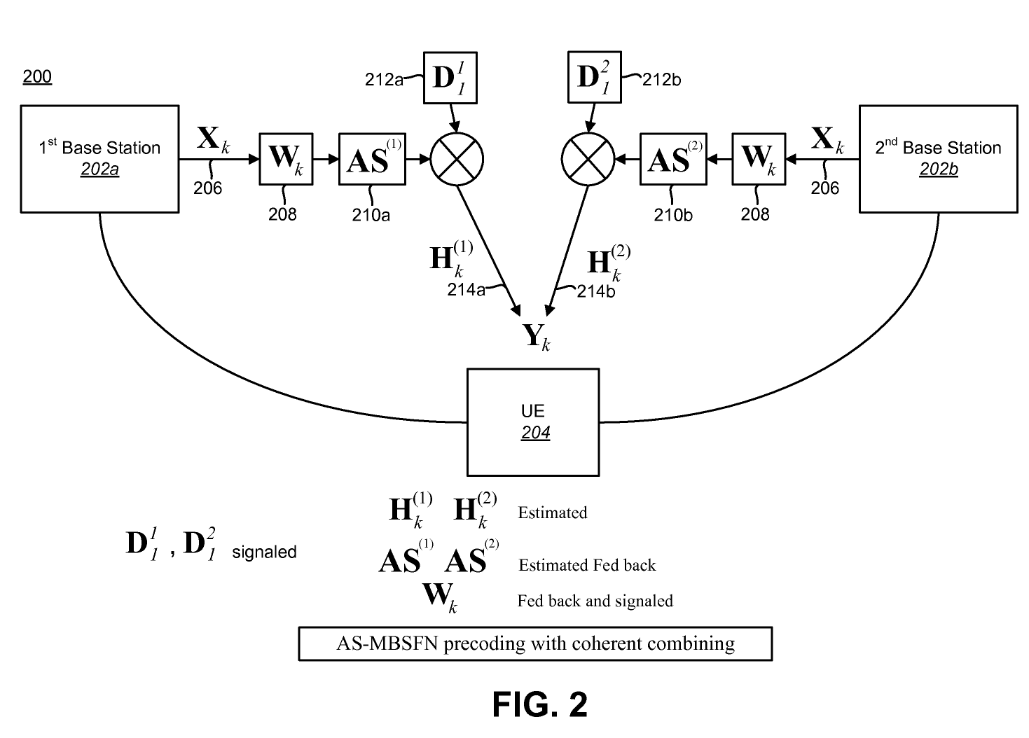

FIG. 2 illustrates a system 200 that is configured for antenna selection with coherent combining preceding. Multiple base stations 202a, 202b are shown transmitting data 206 simultaneously to a UE 204. At the first base station 202a, a preceding vector 208 is applied to the data 206. Then, antenna selection 210a is performed. Then, weights 212a are applied. A separate weight 212a may be applied for each transmit antenna. The resulting signal is transmitted over a first channel 214a to the UE 204. Similarly, at the second base station 202b, a preceding vector 208 is applied to the data 206. Then, antenna selection 210bis performed. Then, weights 212b are applied. A separate weight 212b may be applied for each transmit antenna. The resulting signal is transmitted over a second channel 214b to the UE 204.

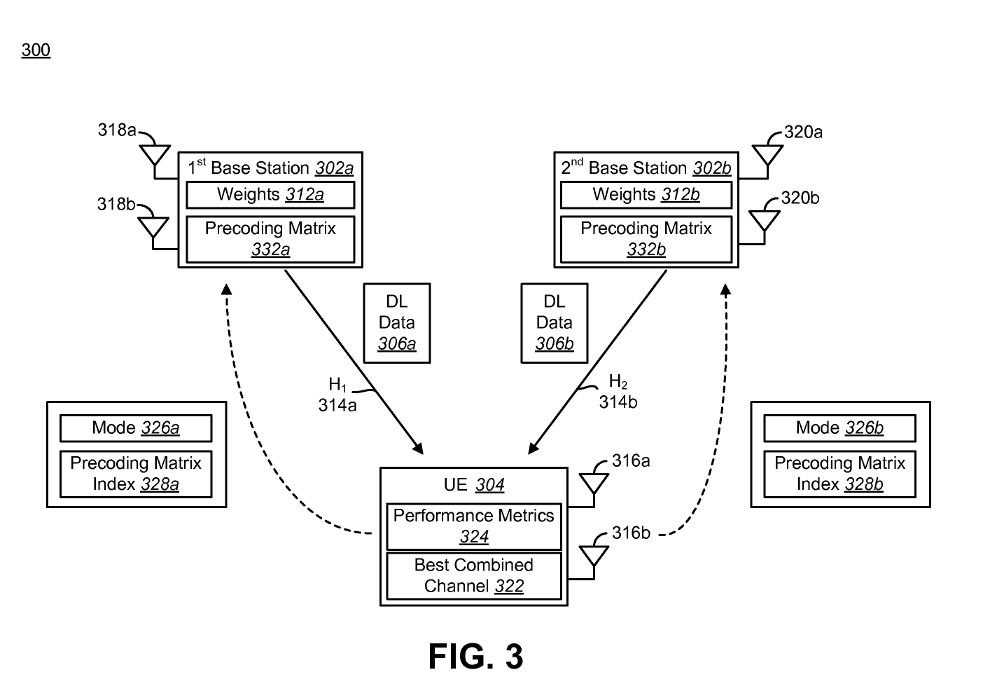

FIG. 3 illustrates another system 300 that is configured for antenna selection with coherent combining precoding. A UE 304 includes a first receiving antenna 316a and a second receiving antenna 316b. A first base station 302a includes a first transmitting antenna 318a and a second transmitting antenna 318b. A second base station 302b includes a first transmitting antenna 320a and a second transmitting antenna 320b. The UE 304 receives downlink data 306a from the first base station 302a via a first channel H₁ 314a. The UE 304 receives the downlink data 306b from the second base station 302b via a second channel H₂ 314b. The system 300 may be a 3GPP LTE-like system, and the downlink data 306 may be downlink shared data (i.e., data that is transmitted on a downlink channel that is shared by multiple UEs).

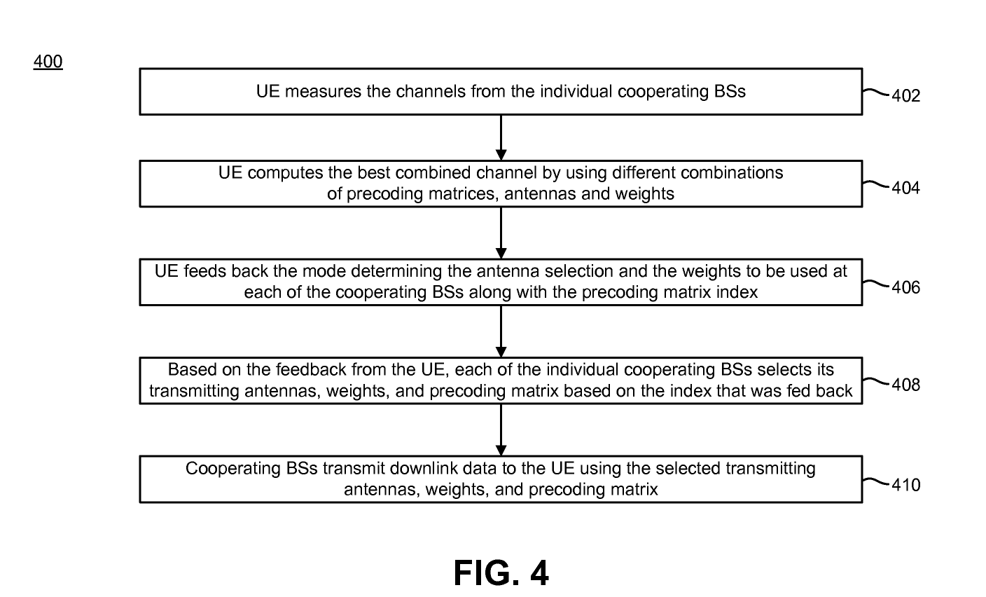

The best combined channel 322, performance metrics 324, modes 326a, 326b, preceding matrix indices 328a, 328b, weights 312a, 312b, and preceding matrices 332a, 332b will be discussed below in connection with FIG. 4.

FIG. 4 illustrates a method 400 for antenna selection with coherent combining preceding. The UE 304 measures 402 the channels H₁ 314a, H₂ 314b from the individual cooperating base stations 302a, 302b (transmission points). The UE 304 computes 404 the best combined channel 322 by using different combinations of preceding matrices 332, antennas 318, 320 and weights 312 for the transmitting base stations 302 using different performance metrics 324. For example, the UE 304 may calculate the preceding matrices 332, antennas 318, 320 and weights 312 from each transmission point based on optimizing a performance criterion (e.g., norm, capacity, determinant, eigenvalue, error rate, etc.), as shown in the following expression:

argmax(D1,D2,W1,W2)f{H1,W1,D1,H2,W2,D2} (3)

One example of a possible function and optimization problem is given by the following expression:

$${argmax}_{{D}_{1} , {D}_{2}} {‖ {H}^{1} {W}^{1} {D}^{1} + {H}^{2} {W}^{2} {D}^{2} ‖}^{2} \qquad ( 3 A )$$

D¹ and D² are chosen to coherently combine the channels and could be of the form diag(e^{jθ}) (diagonal matrix with entries e^{jθ}) and H¹ and H² are obtained by selecting certain columns from H₁ 314a and H₂ 314b, respectively. The diagonal weights can also be the beamforming vectors.

Although expressions (3) and (3A) (and other examples described herein) consider two cooperating base stations, the methods disclosed herein may be extended to more than two base stations.

The weights 312a for the first base station 302a may include a weight for the first transmit antenna 318a and another weight for the second transmit antenna 318b. Similarly, the weights 312b for the second base station 302b may include a weight for the first transmit antenna 320a and another weight for the second transmit antenna 320b.

Antenna selection may also be performed with respect to the UE 304. In other words, the UE 304 may include different combinations of receiving antennas 316 at the UE 304 in order to compute 404 the best combined channel 322. Thus, the UE 304 may compute 404 the best combined channel 322 by using different combinations of preceding matrices 332, transmitting antennas 318, 320 for the base stations 302, receiving antennas 316 at the UE 304, and weights 312.

The UE 304 feeds back 406 by some form at least containing the information of the mode 326 determining the selection of the antenna(s) 318, 320 and the weights 312 to be used at each of the cooperating base stations 302 along with the preceding matrix index 328. The preceding matrices 332 to be used at the different base stations 302 may be the same (i.e., a common preceding matrix 332 may be used), or they may be different. The feedback (e.g., preceding matrices 332) can implicitly include the antenna 318, 320 selection indices and/or the weights 312 to be used for combining.

In order to restrict the possible combinations of antennas 318, 320 and weights 312, a restricted search space could be searched (for instance, with constraints on the minimum number of antennas 318, 320 to be used and/or a subset of the entire weight space). The codewords W¹ and W² are quantized, and multiplying with D¹ and D², respectively, helps in obtaining a larger codebook space given by all possible combinations of W and D. (Note if D=I (i.e., the identity matrix), we search over the original codeword space.)

Based on the feedback from the UE 304, each of the individual cooperating base stations 302 selects 408 its transmitting antennas 318, 320, weights 312, and preceding matrix 332. The cooperating base stations 302 transmit 410 downlink data 306 to the UE 304 using the selected transmitting antennas 318, 320, weights 312, and preceding matrix 332.

Thus, in accordance with the method 400 of FIG. 4, downlink data 306 is transmitted from cooperating base stations 302a, 302b to a UE 304. Different numbers of transmitting antennas 318a, 318b, 320a, 320b may be selected for use at different cooperating base stations 302a, 302b. In addition, coherent weighting may be performed at each of the transmission points (base stations 302a, 302b).

The UE 304 may estimate channels H₁ 314a, H₂ 314b from individual cooperating base stations 302a, 302b and coherently combine the individual channels H₁ 314a, H₂ 314b to form an improved combined channel 322 by selecting the transmit antennas 318a, 318b, 320a, 320b and weights 312a, 312b to be used at each of the transmission points (base stations 302a, 302b). In other words, individual channels H₁ 314a, H₂ 314b may be combined at the UE 304 to form a better combined channel 322 using antenna selection and coherent combining using local weighting. Stated another way, the transmit antennas 318a, 318b, 320a, 320b and weights 312a, 312b of the cooperating base stations 302a, 302b may be selected at the UE 304 by estimating a superimposed channel (i.e., the best combined channel 322) of the cooperating base stations 302a, 302b. Antenna selection indices may be fed back 406 from the UE 304 along with the weights 312a, 312b to be used for coherent combining to the cooperating base stations 302a, 302b in order to allow the individual cooperating base stations 302a, 302b to select the antennas 318a, 318b, 320a, 320b and weights 312a, 312b to be used for transmission.

A specific example will now be described. Let us assume that the channel H₁ 314a from the first base station 302a to the UE 304 is given by:

$$H 1 = [ \begin{matrix}a & b \\ c & d\end{matrix} ] \qquad ( 4 )$$

where a is the channel gain from the first transmitting antenna 318a to the first receiving antenna 316a,b is the gain from the second transmitting antenna 318b to the first receiving antenna 316a, and so on.

Let us assume that the channel H₂ 314b from the second base station 302b to the UE 304 is given by:

$$H 2 = [ \begin{matrix}e & f \\ g & h\end{matrix} ] \qquad ( 5 )$$

Hence, with a normal MBSFN transmission scheme, the combined channel at the receiver (the UE 304) is given by:

$$H = H 1 + H 2 = [ \begin{matrix}a + e & b + f \\ c + g & d + h\end{matrix} ] \qquad ( 6 )$$

However, such a combined channel could be possibly worse than the individual channels H1 or H2 or other combinations of H1 and H2. By using different numbers of antennas 318, 320 and different weights 312 at the individual cooperating base stations 302, a different combined channel will be seen at the receiver and the receiver can choose the optimal combination of antennas 318, 320 and weights 312 at the cooperating base stations 320. Some examples of possible combinations are given below.

Suppose that we choose both transmitting antennas 318a, 318b from the first base station 302a, one transmitting antenna 320a from the second base station 302b, and both receiving antennas 316a, 316b at the UE 304. The combined channel at the UE 304 may be given by:

$$( Mode 1 ) {H}^{′} = [ \begin{matrix}a + e & b \\ c + g & d\end{matrix} ] \qquad ( 7 )$$

With coherent combining, H′=H1+H2*D where D=diag(−1,+1), and hence:

$${H}^{′} = [ \begin{matrix}a - e & b \\ c + g & d\end{matrix} ] \qquad ( 8 )$$

Alternatively, the combined channel at the UE 304 may be given by:

$$( Mode 2 ) {H}^{′} = [ \begin{matrix}a & b + f \\ c & d + h\end{matrix} ] \qquad ( 9 )$$

With coherent combining and with D=diag(+1,−1), we get:

$${H}^{′} = [ \begin{matrix}a & b + f \\ c & d - h\end{matrix} ] \qquad ( 10 )$$

Hence, by using the additional weights 312 in addition to antenna 318, 320 selection, there are more possible ways to superpose the signals from the multiple transmission points than there are by simply using antenna 318, 320 selection alone. Different metrics could be used for the antenna 318, 320 mode selection and weights 312, including but not limited to: the capacity of the combined channel, error rate, the determinant of the combined channel, the norm of the combined channel, the condition number of the combined channel, etc. Thus, the UE 304 may use different metrics to estimate a configuration mode 326 to be used at the cooperating base stations 302 in order to improve a combined channel seen at the UE 304.

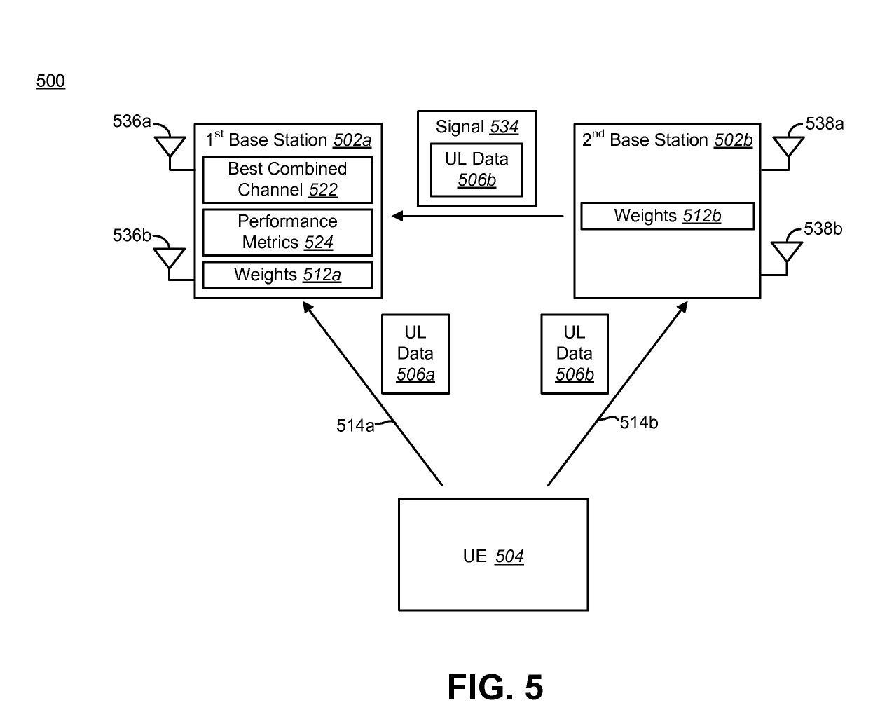

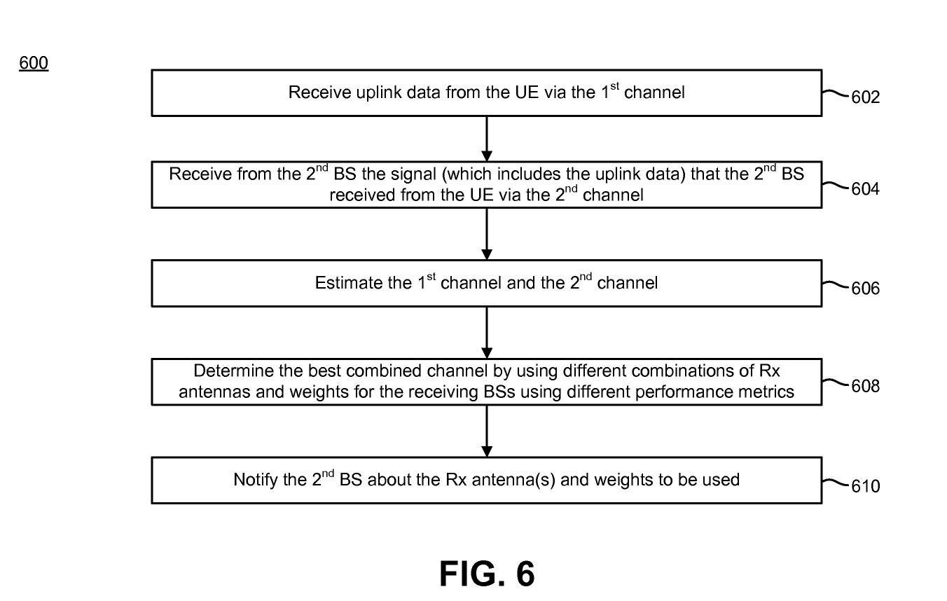

FIG. 5 illustrates another system 500 that is configured for antenna selection with coherent combining preceding. A first base station 502a includes a first receiving antenna 536a and a second receiving antenna 536b. A second base station 502b includes a first receiving antenna 538a and a second receiving antenna 538b. A UE 504 transmits uplink data 506a to the first base station 502a via a first channel 514a. The UE 504 transmits uplink data 506b to the second base station 502b via a second channel 514b. The signal 534, best combined channel 522, performance metrics 524, and weights 512a, 512b will be discussed below in connection with FIG. 6.

FIG. 6 illustrates another method 600 for antenna selection with coherent combining preceding. The first base station 502a receives 602 uplink data 506a from the UE 504 via the first channel 514a. The first base station 502a receives 604 from the second base station 502b the signal 534 (which includes the uplink data 506b) that the second base station 502b received from the UE 504 via the second channel 514b. The first base station 502a estimates 606 the first channel 514a and the second channel 514b. The first base station 502a determines 608 the best combined channel 522 by using different combinations of receiving antennas 536a, 536b, 538a, 538b and weights 512a, 512b for the receiving base stations 502a, 502b using different performance metrics 524. The first base station 502a notifies 610 the second base station 502b about the receiving antenna(s) 538a, 538b and weights 512b to be used.

Thus, in accordance with the method 600 of FIG. 6, uplink data 506 is transmitted from a UE 504 to cooperating base stations 502a, 502b. Different numbers of receive antennas 536a, 536b, 538a, 538b may be selected for use at different cooperating base stations 502a, 502b. In addition, coherent weighting may be performed at each of the reception points (base stations 502a, 502b). A cooperating base station 502a may estimate channels 514a, 514b from the UE 504 to form a better combined channel 522.

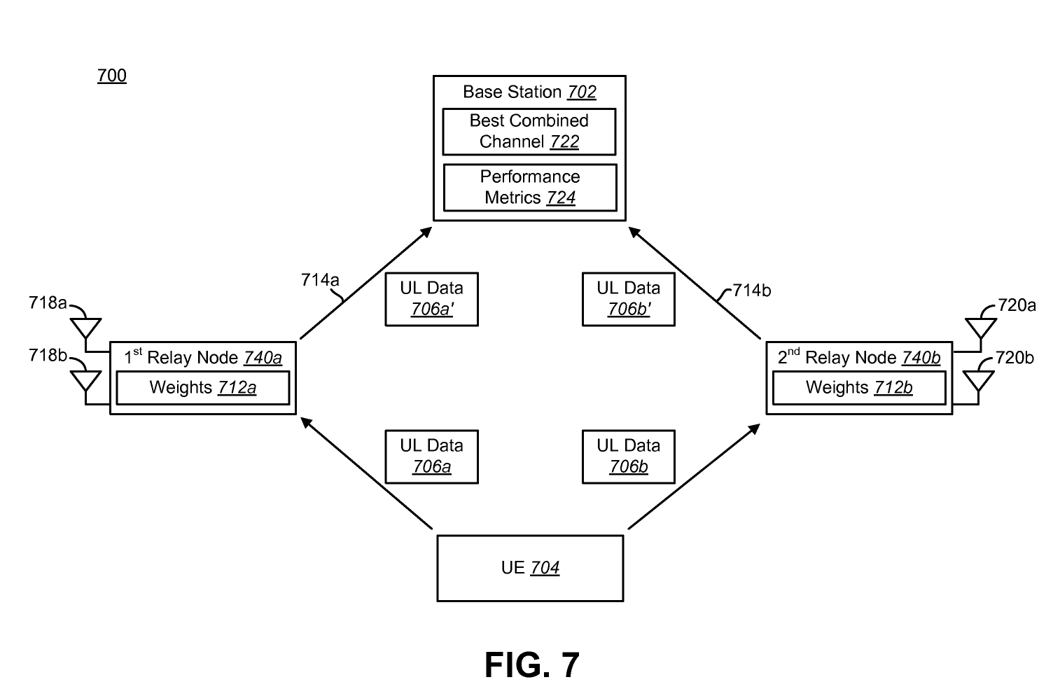

FIG. 7 illustrates another system 700 that is configured for antenna selection with coherent combining preceding. A UE 704 transmits uplink data 706 to a base station 702 via a first relay node 740a and a second relay node 740b. More specifically, the UE 704 transmits the uplink data 706a, 706b to the first relay node 740a and to the second relay node 740b. The first relay node 740a transmits the uplink data 706a′ to the base station 702 via a first channel 714a. The second relay node 740b transmits the uplink data 706b′ to the base station 702 via a second channel 714b. The system 700 may be a 3GPP LTE-like system, and the uplink data 706 may be uplink shared data (i.e., data that i transmitted on an uplink channel that is shared by multiple UEs).

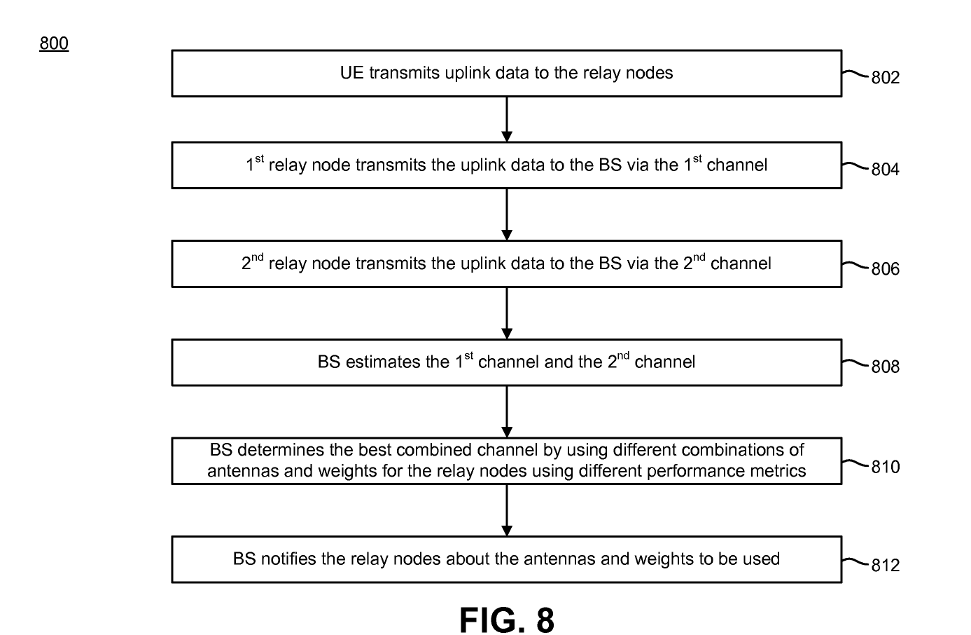

The first relay node 740a includes a first transmitting antenna 718a and a second transmitting antenna 718b. The second relay node 740b includes a first transmitting antenna 720a and a second transmitting antenna 720b. The best combined channel 722, performance metrics 724, and the weights 712a, 712b will be discussed below in connection with FIG. 8.

FIG. 8 illustrates another method 800 for antenna selection with coherent combining preceding. The UE 704 transmits 802 uplink data 706 to the relay nodes 740a, 740b. The first relay node 740a transmits 804 the uplink data 706 to the base station 702 via the first channel 714a. The second relay node 740b transmits 806 the uplink data 706 to the base station 702 via the second channel 714b. The base station 702 estimates 808 the first channel 714a and the second channel 714b. The base station 702 determines 810 the best combined channel 722 by using different combinations of antennas 718a, 718b, 720a, 720b and weights 712a, 712b for the relay nodes 740a, 740b using different performance metrics 724. The base station 702 notifies 812 the relay nodes 740a, 740b about the antennas 718a, 718b, 720a, 720b and weights 712a, 712b to be used.

Thus, in accordance with the method 800 of FIG. 8, individual channels 714a, 714b from the UE 704 to the base station 702 via relay nodes 740a, 740b may be combined to form a better combined channel 722 by selecting transmit antennas 718a, 718b, 720a, 720b and weights 712a, 712b to be used at each of the relay nodes 740a, 740b.

In accordance with the present disclosure, a receiving node (which may be a UE, a base station, etc.) may estimate channels from multiple cooperating transmitting nodes (which may be base stations, relay nodes, etc.). For example, a UE 304 may estimate channels 314a, 314b from multiple cooperating base stations 302a, 302b to the UE 304. As another example, a base station 702 may estimate channels 714a, 714b from multiple relay nodes 740a, 740b to the base station 702.

The receiving node may determine a best combined channel by using different combinations of transmit antennas and weights for the multiple cooperating transmitting nodes. For example, a UE 304 may determine a best combined channel 322 by using different combinations of transmit antennas 318a, 318b, 320a, 320b and weights 312a, 312b for the multiple cooperating base stations 302a, 302b. As another example, a base station 702 may determine a best combined channel 722 by using different combinations of transmit antennas 718a, 718b, 720a, 720b and weights 712a, 712b for the multiple relay nodes 740a, 740b.

The receiving node may notify the multiple cooperating transmitting nodes about the transmit antennas and the weights to be used for transmission of data to the receiving node. For example, a UE 304 may notify the multiple cooperating base stations 302a, 302b about the transmit antennas 318a, 318b, 320a, 320b and the weights 312a, 312b to be used for transmission of downlink data 306 to the UE 304. As another example, a base station 702 may notify the multiple relay nodes 740a, 740b about the transmit antennas 718a, 718b, 720a, 720b and the weights 712a, 712b to be used for transmission of uplink data 706 to the base station 702.

Also, in accordance with the present disclosure, a transmitting node may receive feedback from a receiving node. The feedback may include an indication of one or more transmitting antennas and weights. For example, a cooperating base station 302a may receive from the UE 304 the mode 326a determining the selection of the antenna(s) 318a, 318b and the weights 312a, along with the precoding matrix index 328a. As another example, a relay node 740a may receive from a base station 702 the selection of the antenna(s) 718a, 718b, the weights 712a, and the preceding matrix index.

The transmitting node may select one or more transmitting antennas and the weights to be used for transmission of data to the receiving node based on the feedback from the receiving node. For example, a cooperating base station 302a may select transmitting antenna(s) 318a, 318b and weights 312a to be used for transmission of downlink data 306a to the UE 304 based on the feedback from the UE 304. As another example, a relay node 740a may select transmitting antenna(s) 718a, 718b and weights 712a to be used for transmission of uplink data 706a′ to the base station 702 based on the feedback from the base station 702.

The transmitting node may transmit the data to the receiving node simultaneously with at least one other cooperating transmitting node using the selected transmitting antennas and the selected weights. For example, a cooperating base station 302a may transmit the downlink data 306a to the UE 304 simultaneously with at least one other cooperating base station 302b using the selected transmitting antenna(s) 318a, 318b and the selected weights 312a . As another example, a relay node 740a may transmit uplink data 706a′ to the base station 702 simultaneously with at least one other relay node 740b using the selected transmitting antenna(s) 718a, 718b and the selected weights 712a.

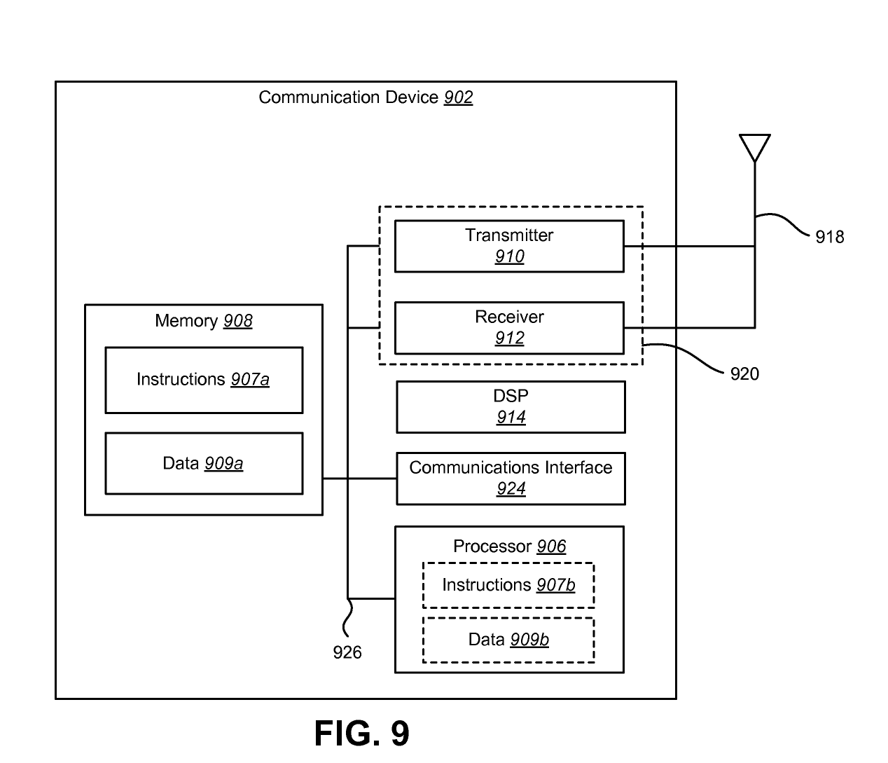

FIG. 9 illustrates various components that may be utilized in a communication device 902. The communication device 902 may be a UE or a base station. The communication device 902 includes a processor 906 that controls operation of the communication device 902. The processor 906 may also be referred to as a CPU. Memory 908, which may include both read-only memory (ROM), random access memory (RAM) or any type of device that may store information, provides instructions 907a and data 909a to the processor 906. A portion of the memory 908 may also include non-volatile random access memory (NVRAM). Instructions 907b and data 909b may also reside in the processor 906. Instructions 907b loaded into the processor 906 may also include instructions 907a from memory 908 that were loaded for execution by the processor 906. The instructions 907 may be executed by the processor 906 to implement the methods disclosed herein.

The communication device 902 may also include a housing that contains a transmitter 910 and a receiver 912 to allow transmission and reception of data. The transmitter 910 and receiver 912 may be combined into a transceiver 920. An antenna 918 is attached to the housing and electrically coupled to the transceiver 920. Additional antennas may also be used.

The various components of the communication device 902 are coupled together by a bus system 926 which may include a power bus, a control signal bus, and a status signal bus, in addition to a data bus. However, for the sake of clarity, the various buses are illustrated in FIG. 9 as the bus system 926. The communication device 902 may also include a digital signal processor (DSP) 914 for use in processing signals. The communication device 902 may also include a communications interface 924 that provides user access to the functions of the communication device 902. The communication device 902 illustrated in FIG. 9 is a functional block diagram rather than a listing of specific components.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for coordinated multipoint transmission/reception, comprising:
transmitting downlink data from cooperating base stations to a user equipment (UE);
selecting different numbers of transmit antennas for use at different cooperating base stations; and
performing coherent weighting at each of the transmission points.

2. The method of claim 1, further comprising:
transmitting uplink data from the UE to the cooperating base stations;
selecting different numbers of receive antennas for use at different cooperating base stations; and
performing coherent weighting at each of the reception points.

3. The method of claim 1, further comprising the UE estimating channels from individual cooperating base stations and combining the individual channels to form an improved combined channel by selecting the transmit antennas and weights to be used at each transmission point.

4. The method of claim 1, further comprising combining individual channels at the UE to form a better combined channel using antenna selection and coherent combining using local weighting.

5. The method of claim 1, further comprising selecting the transmit antennas and weights of the cooperating base stations at the UE by estimating a superimposed channel of the cooperating base stations.

6. The method of claim 1, further comprising the UE estimating channels from individual cooperating base stations and coherently combining them to form an improved combined channel.

7. The method of claim 1, further comprising a cooperating base station estimating channels from the UE to form a better combined channel.

8. The method of claim 1, further comprising combining individual channels from the UE to a base station via relay nodes to form a better combined channel by selecting transmit antennas and weights to be used at each of the relay nodes.

9. The method of claim 1, further comprising feeding back antenna selection indices from the UE along with the weights to be used for coherent combining to the cooperating base stations in order to allow the individual cooperating base stations to select the antennas and weights to be used for transmission.

10. The method of claim 1, further comprising feeding back a precoding matrix indicator from the UE that implicitly takes into account antenna selection indices and the weights to be used for coherent combining.

11. The method of claim 1, wherein the downlink data to be transmitted is downlink shared data in a 3GPP LTE-like system.

12. The method of claim 2, wherein the uplink data to be transmitted is uplink shared data in a 3GPP LTE-like system.

13. The method of claim 1, further comprising the UE using different metrics to estimate a configuration mode to be used at the cooperating base stations in order to improve a combined channel seen at the UE.

14. The method of claim 1, further comprising performing antenna selection with respect to the UE.

15. The method of claim 2, further comprising performing antenna selection with respect to the UE.

16. A receiving node, comprising:
a processor;
memory in electronic communication with the processor; and
instructions stored in the memory, the instructions being executable to:
estimate channels from multiple cooperating transmitting nodes to the receiving node;
determine a best combined channel by using different combinations of transmit antennas and weights for the multiple cooperating transmitting nodes; and
notify the multiple cooperating transmitting nodes about the transmit antennas and the weights to be used for transmission of data to the receiving node.

17. The receiving node of claim 16, wherein the receiving node is a user equipment (UE), and wherein the transmitting nodes are base stations.

18. The receiving node of claim 16, wherein the receiving node is a base station, and wherein the transmitting nodes are relay nodes or UEs.

19. The receiving node of claim 16, wherein determining the best combined channel comprises optimizing a performance criterion.

20. A transmitting node, comprising:
a processor;
memory in electronic communication with the processor; and
instructions stored in the memory, the instructions being executable to:
receive feedback from a receiving node, wherein the feedback comprises an indication of one or more transmitting antennas and weights;
select the one or more transmitting antennas and the weights to be used for transmission of data to the receiving node based on the feedback from the receiving node; and
transmit the data to the receiving node simultaneously with at least one other cooperating transmitting node using the selected transmitting antennas and the selected weights.

21. The transmitting node of claim 20, wherein the receiving node is a user equipment (UE), and wherein the transmitting node and the at least one other cooperating transmitting node are base stations.

22. The transmitting node of claim 20, wherein the receiving node is a base station, and wherein the transmitting node and the at least one other cooperating transmitting node are relay nodes or UEs.
